(19) United States
(12) Patent Application Publication
(10) Pub. No.: US 2026/0027913 A1
(43) Pub. Date: Jan. 29, 2026

(54) VEHICLE BOTTOM STRUCTURE

(71) Applicant: TOYOTA JIDOSHA KABUSHIKI KAISHA, Toyota-shi (JP)

(72) Inventors: Fumio NOMIZO, Toyota-shi (JP); Katsunori HIGASHIHARA, Toyota-shi (JP); Kazuki FUNAHASHI, Nagoya-shi (JP); Yuuji MIZUTANI, Toyota-shi (JP)

(73) Assignee: TOYOTA JIDOSHA KABUSHIKI KAISHA, Toyota-shi (JP)

(21) Appl. No.: 19/068,151

(22) Filed: Mar. 3, 2025

(30) Foreign Application Priority Data
Jul. 26, 2024 (JP) 2024-120977

(51) Int. Cl. B60L 50/64; B60L 50/60; B62D 21/15; B62D 25/20; H01M 50/249; H01M 50/262

(52) U.S. Cl. CPC B60L 50/64; B60L 50/66; B62D 21/15; B62D 25/20; H01M 50/249; H01M 50/262; H01M 2220/20

(57) ABSTRACT

The vehicle bottom structure includes a battery pack mounted below the floor, a plurality of outer cross members below the battery pack and spaced apart in the vehicle front-rear direction, and a share panel covering the bottom plate of the battery pack. The outer cross member has an upwardly open hat-shaped cross section and is attached to the outer surface of the bottom plate of the battery pack. A reinforcing member extending in the vehicle width direction is disposed between the lower wall of the outer cross member and the share panel. The lower walls of the share panel, the reinforcing member, and the outer cross member are superposed and fastened with bolts. Both end portions of the lower surface of the reinforcing member in the vehicle front-rear direction are located outward from both end portions of the lower wall of the outer cross member in the vehicle front-rear direction.

### CROSS-REFERENCE TO RELATED APPLICATION

This application claims priority to Japanese Patent Application No. 2024-120977 filed on Jul. 26, 2024. The disclosure of the above-identified application, including the specification, drawings, and claims, is incorporated by reference herein in its entirety.

### BACKGROUND

### 1. Technical Field

The present disclosure relates to a bottom structure of an electrified vehicle in which a battery pack is mounted below a floor.

### 2. Description of Related Art

Electrified vehicles such as battery electric vehicles (BEVs) are known. An electrified vehicle includes a battery pack that supplies electric power to a travel motor. The battery pack is mounted below the floor of a vehicle cabin.

Japanese Unexamined Patent Application Publication No. 2023-87250 (JP 2023-87250 A) discloses a battery case that is mounted under the floor of a vehicle cabin of a battery electric vehicle and in which a battery is stored.

### SUMMARY

An electrified vehicle includes a battery pack mounted below the floor. The electrified vehicle includes a plurality of outer cross members disposed below the battery pack at intervals in the vehicle front-rear direction. The electrified vehicle includes a share panel disposed below the outer cross members to cover the battery pack from below. The share panel forms a vehicle bottom surface below the floor.

The battery pack has a case that accommodates a battery module. Each of the outer cross members has a hat-shaped cross section opened upward, extends in the vehicle width direction, and is attached to the outer surface of a bottom plate of the case of the battery pack. A lower wall (web) of each of the outer cross members and the share panel are stacked and fastened by bolts. That is, the share panel is held by the outer cross members at intervals in the vehicle front-rear direction.

When an object collides with the share panel from the vehicle lower side, the share panel deflects upward between two fastening points (fastening points with two outer cross members) of the share panel in the vehicle front-rear direction. This may cause the share panel to approach the battery pack and damage the battery pack. It is desired to reduce the amount of upward deflection of the share panel when an object collides with the share panel from the vehicle lower side.

The present disclosure provides a vehicle bottom structure capable of reducing upward deflection of a share panel when an object collides with the share panel from the vehicle lower side.

An aspect of the present disclosure provides a vehicle bottom structure including: a battery pack having a case that accommodates a battery module inside, the battery pack being mounted below a floor; a plurality of outer cross members located below a bottom plate of the case and disposed at intervals in a vehicle front-rear direction; and a share panel disposed below the outer cross members to cover the bottom plate of the case, in which: the outer cross members each have a hat-shaped cross section opened upward, extend in a vehicle width direction, and is attached to an outer surface of the bottom plate of the case; a reinforcing member extending in the vehicle width direction is disposed between a lower wall of each of the outer cross members and the share panel; the share panel, the reinforcing member, and the lower wall of the outer cross member are stacked and fastened by bolts; and both end portions of a lower surface of the reinforcing member in the vehicle front-rear direction are located outward of both end portions of the lower wall of the outer cross member in the vehicle front-rear direction.

According to this configuration, when an object collides with the share panel from the vehicle lower side, the distance between the fulcrums of the bending moment of the share panel is shorter than when the share panel is directly fastened to the lower wall of the outer cross member. That is, the distance between the fulcrums of the bending moment of the share panel is shortened by the reinforcing member whose both end portions in the vehicle front-rear direction are located outward of the outer cross member. Thus, it is possible to reduce the upward deflection of the share panel.

In the vehicle bottom structure according to the aspect of the present disclosure, the reinforcing member and the share panel may be bonded by an adhesive.

According to this configuration, when an object collides with the share panel from the vehicle lower side, the share panel is restricted from moving toward the object that collides with the reinforcing member. Thus, it is possible to suppress the upward deflection of the share panel.

In the vehicle bottom structure according to the aspect of the present disclosure, the lower wall of the outer cross member may have a projecting portion projecting downward; an upper surface of the reinforcing member may have a recessed portion that receives the projecting portion of the outer cross member; the recessed portion of the reinforcing member may have a plurality of bolt through holes provided at intervals in the vehicle width direction to allow the bolts to pass through the bolt through holes; putty may be disposed in a non-bolt region between adjacent bolt through holes in the recessed portion of the reinforcing member, the putty filling a space between an inner surface of the recessed portion and an outer surface of the projecting portion of the outer cross member; and the projecting portion of the outer cross member may be detachable from the putty.

According to this configuration, it is possible to restrict the non-bolt region of the reinforcing member moving with respect to the outer cross member when an object collides with the share panel from the vehicle lower side. Therefore, it is possible to suppress the share panel approaching the battery pack. Putty (gap filler) is disposed between the inner surface of the recessed portion of the reinforcing member and the outer surface of the projecting portion of the outer cross member. Therefore, rattling between the non-bolt region of the reinforcing member and the outer cross member can be suppressed. The projecting portion of the outer cross member is detachable from the putty. Therefore, the share panel can be removed from the outer cross member by releasing the bolt fastening of the outer cross member and the share panel. Therefore, it is possible to improve the maintainability of the vehicle.

In the vehicle bottom structure according to the aspect of the present disclosure, the recessed portion of the reinforcing member may include: a first recessed portion; and a second recessed portion provided in a center portion of the first recessed portion in the vehicle front-rear direction.

According to this configuration, it is possible to suppress the putty in the recessed portion of the reinforcing member overflowing outward at the time of manufacturing the vehicle. That is, when the putty is disposed in the recessed portion of the reinforcing member at the time of manufacturing the vehicle, a second recessed portion is filled with softened putty. Then, the reinforcing member and the share panel are assembled to the outer cross member. In this way, the projecting portion of the outer cross member enters the putty in the second recessed portion of the reinforcing member, and thereafter the putty hardens. According to the configuration described above, when the projecting portion of the outer cross member enters the putty in the second recessed portion of the reinforcing member, the putty overflowing from the second recessed portion can be received by a first recessed portion. Therefore, it is possible to suppress the putty overflowing outward of the reinforcing member.

In the vehicle bottom structure according to the aspect of the present disclosure, the reinforcing member may have a plurality of bolt through holes provided at intervals in the vehicle width direction to allow the bolts to pass through the bolt through holes; and an upper surface of the reinforcing member may have a dent extending in a longitudinal direction of the reinforcing member in a non-bolt region between adjacent bolt through holes.

According to this configuration, when a load is input to the reinforcing member, a stress can be dispersed in the recess in the reinforcing member, suppressing concentration of the stress in the bolt through hole.

According to the technology of the present disclosure, it is possible to reduce upward deflection of a share panel when an object collides with the share panel from the vehicle lower side.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating an upper surface of a share panel of a vehicle according to an embodiment;

FIG. 2 is a cross-sectional view taken along II-II line of FIG. 1;

FIG. 3 is a cross-sectional view of a bolt region of a reinforcing member in another embodiment;

FIG. 4 is a cross-sectional view of a non-bolt region of a reinforcing member in another embodiment;

FIG. 5 is a view for explaining how a putty is arranged in a recessed portion of a reinforcing member; and

FIG. 6 is a perspective view of a portion of a reinforcing member of yet another embodiment.

### DETAILED DESCRIPTION OF EMBODIMENTS

Hereinafter, embodiments will be described with reference to the drawings. In all the drawings, equivalent elements are denoted by the same reference numerals, and redundant description is omitted. In the following description, unless otherwise specified, the terms indicating the front-rear, right-left, and up-down, etc. directions indicate the directions related to a vehicle. In the drawings, the direction of the arrow FR indicates the front side, the direction of the arrow UP indicates the upper side, and the direction of the arrow RH indicates the right side.

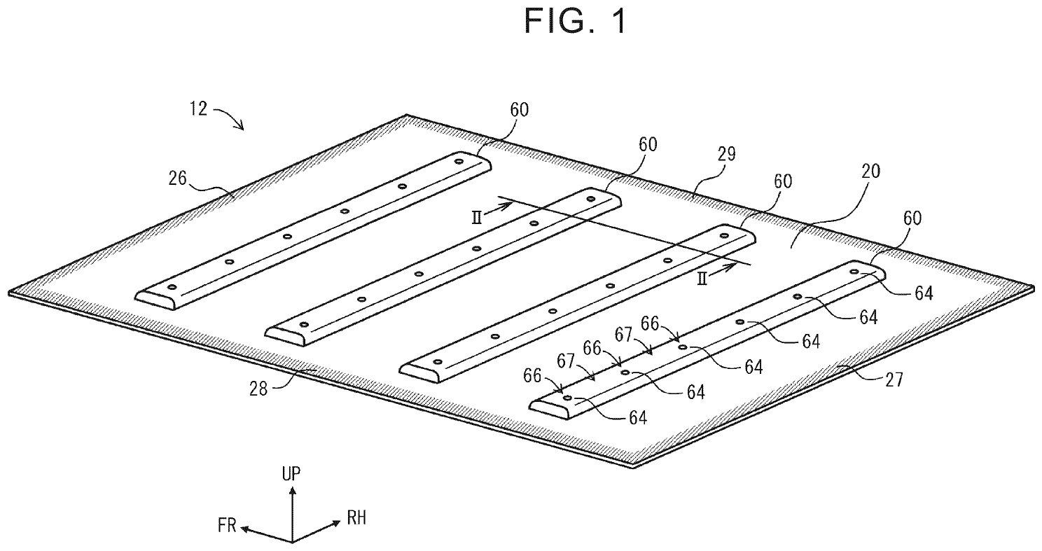

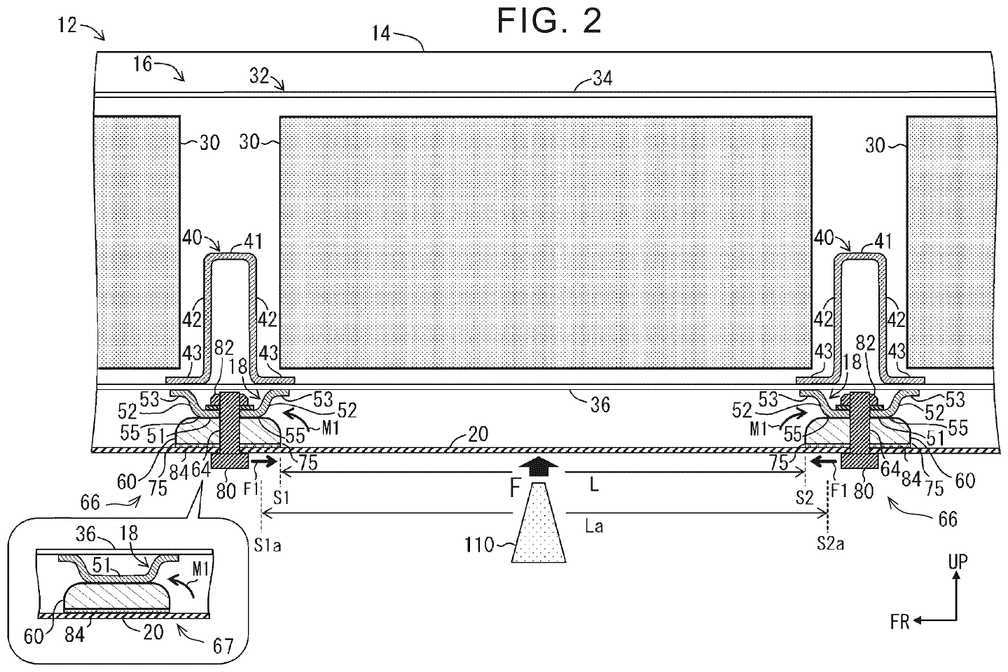

FIG. 1 is a perspective view schematically illustrating an upper surface of a share panel 20 of a vehicle 12. FIG. 2 is a cross-sectional view taken along II-II of FIG. 1 and also shows the battery pack 16 and the floor 14 located above the share panel 20. The vehicles 12 are electrified vehicle such as battery electric vehicle, hybrid battery electric vehicle, and plug-in hybrid battery electric vehicle. Electrified vehicle includes a battery pack 16 that supplies electric power to a motor (not shown) serving as a power source.

As shown in FIG. 2, the battery pack 16 is mounted below the floor 14 of the vehicle cabin. The vehicle 12 includes a share panel 20 that covers the battery pack 16 from below. The share panel 20 forms a vehicle bottom surface below the floor 14.

The battery pack 16 includes a plurality of battery modules 30 and a case 32. The battery module 30 includes a battery stack in which a plurality of battery cells is stacked. The case 32 is an outer shell of the battery pack 16. The case 32 houses a plurality of battery modules 30 therein. The case 32 includes a lower case and an upper case. The lower case has, for example, a bathtub shape, and the upper case has, for example, an inverted bathtub shape (a shape in which the bathtub is inverted). An upper case is fixed on the lower case. FIG. 2 shows the bottom plate 36 of the lower case and the top plate 34 of the upper case.

A plurality of inner cross members 40 is attached to the upper surface of the bottom plate 36 of the case 32. The inner cross member 40 is disposed in a gap between the adjacent battery modules 30 and extends in the vehicle width direction (vehicle left-right direction). The inner cross member 40 is a folded plate member having a hat-shaped cross section. The inner cross member 40 includes a web 41, a pair of flanges 42 erected at opposite ends of the web 41, and a pair of arms 43 extending outward from tips of the pair of flanges 42. The arm 43 of the inner cross member 40 is joined to the upper surface of the bottom plate 36.

The vehicle 12 includes a plurality of outer cross members 18. The plurality of outer cross members 18 are located below the bottom plate 36 of the case 32 and are spaced apart from each other in the vehicle front-rear direction. The outer cross member 18 has an upwardly open hat-shaped cross section. The outer cross member 18 is a folded plate member. The outer cross member 18 extends in the vehicle width direction. The outer cross member 18 includes a lower wall 51 (web), a pair of flanges 52 erected on both side ends of the lower wall 51, and a pair of arms 53 extending outward from the tips of the pair of flanges 52. The arm 53 of the outer cross member 18 is joined to the lower surface of the portion of the bottom plate 36 to which the arm 43 of the inner cross member 40 is joined. A weld nut 82 is welded to the inside of the outer cross member 18.

The vehicle 12 includes a plurality of reinforcing members 60 (reinforcement). The reinforcing member 60 is an elongated plate-like member extending in the vehicle width direction. The reinforcing member 60 may be, for example, an extruded metal material, a steel material, a resin material, or the like. The reinforcing member 60 is disposed between the lower wall 51 of the outer cross member 18 and the share panel 20. The reinforcing member 60 is bonded to the upper surface of the share panel 20 with an adhesive 84. That is, as shown in FIG. 1, the reinforcing member 60 is coupled to the share panel 20 at intervals in the vehicle front-rear direction. Each reinforcing member 60 is located on the vehicle width direction inner side of each of the left end 28 and the right end 29 of the share panel 20.

The reinforcing member 60 is provided with a plurality of bolt through holes 64 spaced apart in the vehicle width direction. A bolt 80 (see FIG. 2) inserted from below the share panel 20 is passed through each bolt through-hole 64. Hereinafter, a region in which the bolt through-hole 64 of the reinforcing member 60 is provided is referred to as a bolt region 66 (see FIG. 1). A region between adjacent bolt through-holes 64 of the reinforcing member 60 is referred to as a non-bolt region 67. In II-II section of FIG. 2, the bolt regions 66 of the two reinforcing members 60 are shown. The blowout of FIG. 2 shows a non-bolt region 67 of one reinforcing member 60.

The share panel 20 is a bottom plate of a vehicle, and has a substantially rectangular shape whose longitudinal direction is the vehicle front-rear direction in a plan view. The share panel 20 may be made of, for example, an aluminum material, a high-tensile material (steel material having high tensile strength), or the like. The share panel 20 includes a front end 26, a rear end 27, a left end 28, and a right end 29. Although not shown, the front end 26, the rear end 27, the left end 28, and the right end 29 are machined into a desired shape so as to be attachable to a skeletal member of a vehicle. The front end 26, the rear end 27, the left end 28, and the right end 29 of the share panel 20 are respectively attached to the skeleton members of the front portion of the vehicle body, the rear portion of the vehicle body, the left portion of the vehicle body, and the right portion of the vehicle body.

As shown in FIG. 2, the share panel 20, the reinforcing member 60, and the lower wall 51 of the outer cross member 18 are stacked and fastened with bolts 80. The bolt 80 passes through the share panel 20. The bolt 80 passes through the bolt through hole 64 of the reinforcing member 60 and passes through the lower wall 51 of the outer cross member 18. The bolt 80 is fastened to the weld nut 82 of the outer cross member 18. The reinforcing member 60 is provided with fastening points (bolt regions 66) by the bolt 80 and the nut 82 side by side at intervals in the vehicle width direction.

As shown in FIG. 2, in each of the plurality of reinforcing members 60, both end portions 75 in the vehicle front-rear direction on the lower surface of the reinforcing member 60 are located outward from both end portions 55 in the vehicle front-rear direction of the lower wall 51 of the outer cross member 18.

According to the embodiment described above, as shown in FIG. 2, when the object 110 on the road surface collides with the share panel 20 and the collision load Fis input to the share panel 20, the upward deflection of the share panel 20 can be reduced. That is, the share panel 20 is directly fastened to the lower wall 51 of each outer cross member 18. In this case, a distance La between the rear end 55 of the front outer cross member 18 and the front end 55 of the rear outer cross member 18 is a distance between the fulcrums of the bending moment of the share panel 20 at the time of an object collision. The rear end 55 of the front outer cross member 18 is indicated by the reference S1a in FIG. 2. The front end 55 of the rear outer cross member 18 is indicated by the reference S2a in FIG. 2.

On the other hand, according to the embodiment described above, the reinforcing member 60 is disposed between the share panel 20 and the lower wall 51 of the outer cross member 18. Both end portions 75 of the lower surface of the reinforcing member 60 in the vehicle front-rear direction are located outward of both end portions 55 of the lower wall 51 of the outer cross member 18 in the vehicle front-rear direction. Therefore, the distance between the rear end 75 (reference numeral S1 in FIG. 2) of the front reinforcing member 60 and the front end 75 (reference numeral S2) of the rear reinforcing member 60 is the distance L between the fulcrums of the bending moment of the share panel 20 at the time of an object collision. In this case, the distance L between the fulcrums of the bending moment is shorter than that in the case where the share panel 20 is directly fastened to the outer cross member 18 (L<La). Therefore, when the object 110 collides with the share panel 20, the upward deflection of the share panel 20 can be reduced.

Further, according to the embodiment described above, the reinforcing member 60 and the share panel 20 are joined by the adhesive 84. When the object 110 collides with the share panel 20 from the lower side of the vehicle, as shown by the arrow F1 in FIG. 2, a force that the share panel 20 attempts to move from the reinforcing member 60 is generated. That is, the share panel 20 attempts to move toward the colliding object 110. However, according to the embodiment described above, since the share panel 20 is coupled to the reinforcing member 60, it is possible to restrict the movement of the share panel 20 with respect to the reinforcing member 60. Therefore, the upward deflection of the share panel 20 can be reduced.

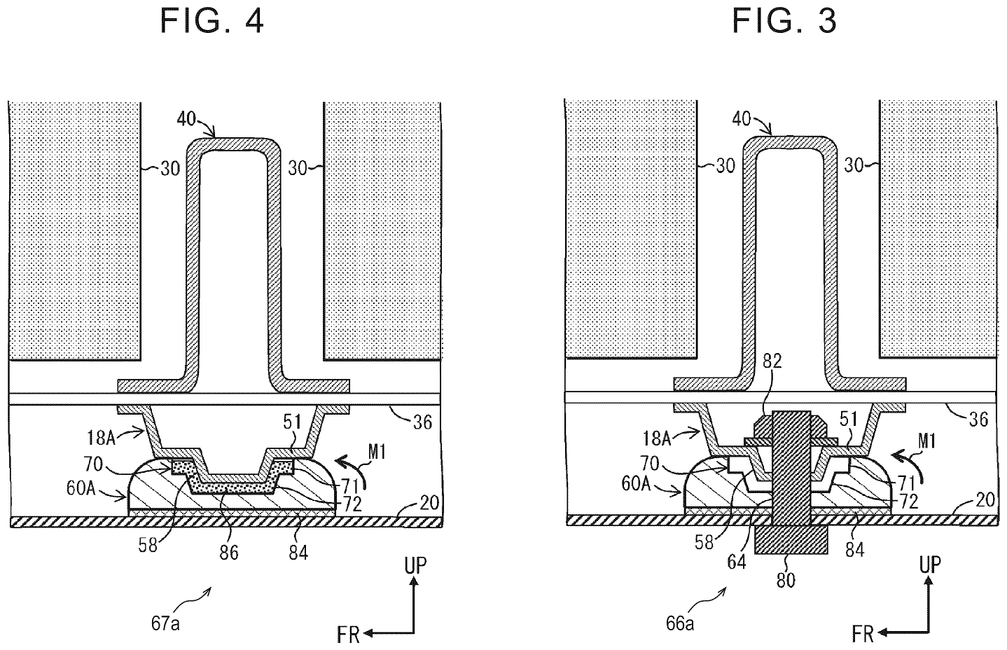

Next, another embodiment will be described. FIG. 3 is a cross-sectional view showing the bolt-region 66a of the reinforcing member 60A in this alternative embodiment. FIG. 4 is a cross-sectional view showing the non-bolt region 67a of the reinforcing member 60A in this alternative embodiment. In this embodiment, the lower wall 51 of the outer cross member 18A has a projecting portion 58 protruding downward. Further, the upper surface of the reinforcing member 60 has a recessed portion 70 for receiving the projecting portion 58 of the outer cross member 18A. A putty 86 (gap filler) is disposed in the recessed portion 70 of the reinforcing member 60 on the non-bolt region 67a. Other configurations are the same as those of the embodiment described with reference to FIGS. 1 and 2.

The projecting portion 58 of the outer cross member 18A is formed by bending the lower wall 51 so as to have a hat-shaped cross section. The outer cross member 18A has the same or substantially the same cross-sectional profile along the vehicle-width direction.

The recessed portion 70 of the reinforcing member 60A includes a first recessed portion 71 and a second recessed portion 72 provided in a vehicle-front-rear direction central portion (short-side direction central portion of the reinforcing member 60A) of the first recessed portion 71. The reinforcing member 60A has the same or substantially the same cross-sectional profile along the vehicle-width direction.

A plurality of bolt through holes 64 are provided in the recessed portion 70 of the reinforcing member 60A so as to allow the bolts 80 to pass therethrough with a space therebetween. A putty 86 is disposed in the non-bolt region 67a between adjacent bolt through holes 64 in the recessed portion 70 of the reinforcing member 60. The putty 86 fills the space between the inner surface of the recessed portion 70 and the outer surface of the protrusion 58 of the outer cross member 18A. The projecting portion 58 of the outer cross member 18A is detachable from the putty 86. This is achieved, for example, by applying a release agent to the outer surface of the projecting portion 58 of the outer cross member 18A.

The operation and effect of this other embodiment will be described. As shown in FIG. 2, when the object 110 collides with the share panel 20 from the lower side of the vehicle and the share panel 20 is bent upward, a moment M1 is generated in the reinforcing member 60. As a result, in the non-bolt region 67, the reinforcing member 60 moves with respect to the lower wall 51 of the outer cross member 18, as shown in the blow-out of FIG. 2. As a result, the upward deflection of the share panel 20 may increase.

However, according to this alternative embodiment, in the non-bolt region 67a, as shown in FIG. 4, the protrusion 58 of the outer cross member 18A enters the putty 86 of the recessed portion 70 of the reinforcing member 60A. Therefore, it is possible to restrict the reinforcing member 60A from moving with respect to the lower wall 51 of the outer cross member 18. Therefore, the upward deflection of the share panel 20 can be reduced.

Further, a putty 86 (gap filler) is disposed between the inner surface of the recessed portion 70 of the non-bolt region 67a of the reinforcing member 60A and the outer surface of the projecting portion 58 of the outer cross member 18A. Therefore, backlash between the non-bolt region 67a of the reinforcing member 60A and the outer cross member 18A can be suppressed.

Further, the projecting portion 58 of the outer cross member 18A is detachable from the putty 86. Therefore, by releasing the fastening of the bolt 80 between the outer cross member 18A and the share panel 20, the share panel 20 can be removed from the outer cross member 18A. Therefore, it is possible to improve the maintainability of the vehicle.

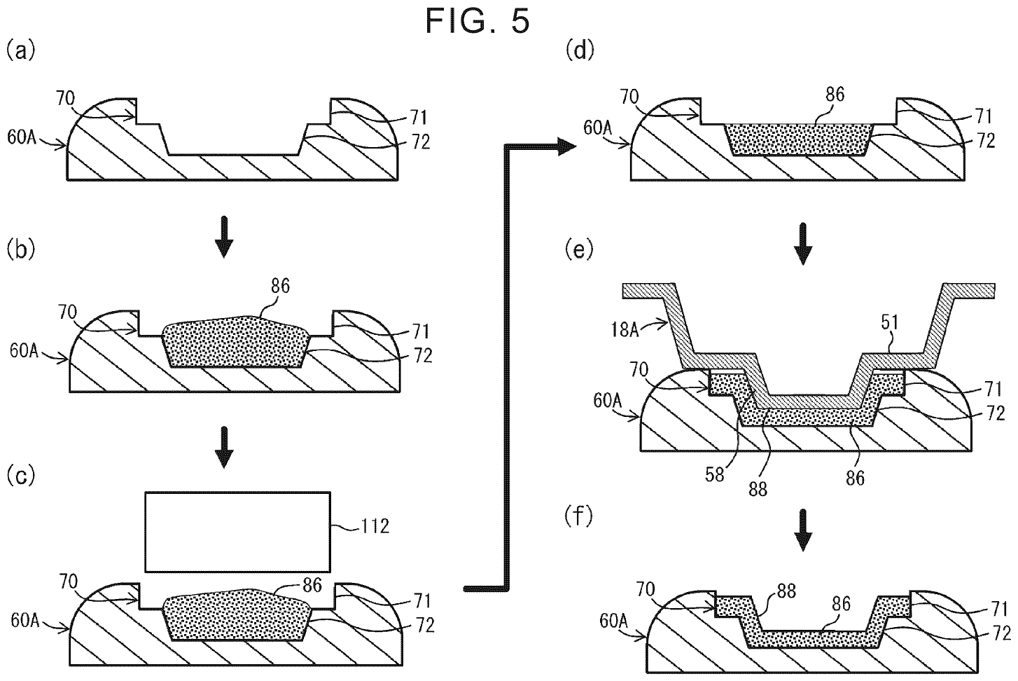

Here, methods of disposing the putty 86 in the recessed portion 70 of the reinforcing member 60A at the time of manufacturing the vehicles will be described. FIG. 5 shows steps (a) to (f) of disposing the putty 86 in the recessed portion 70 of the reinforcing member 60A.

In step (a), a share panel 20 in which a plurality of reinforcing member 60A are fixed with an adhesive is prepared.

In step (b), the softened putty 86 is poured into the recessed portion 70 in the non-bolted area of the reinforcing member 60A. At this time, the blocking member may be disposed between the non-bolt region and the bolt region of the recessed portion 70 so that the putty 86 does not flow into the bolt region of the reinforcing member 60A.

In step (c), the spatula 112 is used to fill the putty 86 only in the second recessed portion 72. Specifically, the spatula 112 is moved in the longitudinal direction of the reinforcing member 60A while being applied to the lower surfaces of both ends of the first recessed portion 71, thereby removing the putty 86 protruding from the second recessed portion 72.

In step (d), the putty 86 is cured to an extent that some flexibility remains. At this time, in the case where the blocking member is disposed in the above-described step (b), the blocking member may be removed.

In step (e), a release agent is applied to the protrusions 58 of the plurality of outer cross member 18A. Then, the share panel 20 in which the plurality of reinforcing members 60A (putty-filled) are fixed to the plurality of outer cross member 18A is fastened by the plurality of bolts 80. At this time, the protrusions 58 of the outer cross member 18A enter the putties 86 of the second recessed portions 72 of the reinforcing member 60A. The putty 86 will then cure. As a result, a recessed portion 88 corresponding to the projecting portion 58 of the outer cross member 18A is formed in the putty 86.

According to this embodiment, when the projecting portion 58 of the outer cross member 18A enters the putty 86 of the second recessed portion 72 on the reinforcing member 60A, the putty 86 overflowing from the second recessed portion 72 can be received by the first recessed portion 71. Therefore, it is possible to suppress the putty 86 overflowing outward of the reinforcing member 60A.

Further, a release agent is applied to the protrusions 58 of the plurality of outer cross member 18A. Therefore, as shown in step (f), during maintenance of the vehicle, the protrusion 58 of the outer cross member 18A is separated from the recessed portion 88 of the putty, it is possible to remove the share panel 20 from the outer cross member 18A.

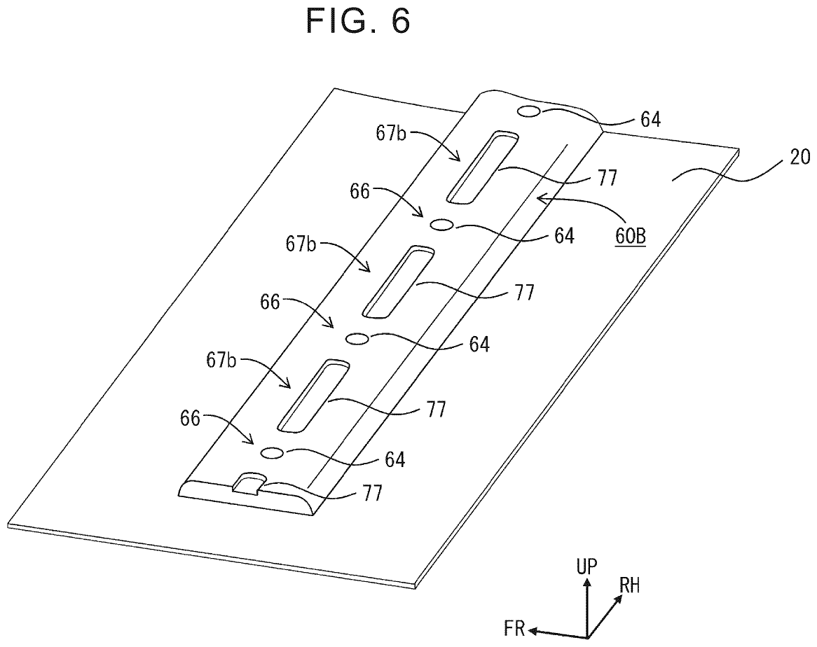

Next, still another embodiment will be described. FIG. 6 is a perspective view showing a part of the reinforcing member 60B of this embodiment. In this embodiment, the upper surface of the reinforcing member 60B has a longitudinally extending recess 77 (recess) of the reinforcing member 60B in the non-bolt region 67b between adjacent bolt through holes 64 (bolt regions 66). Other configurations are the same as those of the embodiment described with reference to FIGS. 1 and 2.

According to this embodiment, when a load is inputted to the reinforcing member 60B, the stress can be dispersed in the recess 77 in the reinforcing member 60B, and the stress can be suppressed from being concentrated in the bolt-through hole 64.

What is claimed is:

1. A vehicle bottom structure comprising:
a battery pack having a case that accommodates a battery module inside, the battery pack being mounted below a floor;
a plurality of outer cross members located below a bottom plate of the case and disposed at intervals in a vehicle front-rear direction; and
a share panel disposed below the outer cross members to cover the bottom plate of the case, wherein:
the outer cross members each have a hat-shaped cross section opened upward, extend in a vehicle width direction, and is attached to an outer surface of the bottom plate of the case;
a reinforcing member extending in the vehicle width direction is disposed between a lower wall of each of the outer cross members and the share panel;
the share panel, the reinforcing member, and the lower wall of the outer cross member are stacked and fastened by bolts; and
both end portions of a lower surface of the reinforcing member in the vehicle front-rear direction are located outward of both end portions of the lower wall of the outer cross member in the vehicle front-rear direction.

2. The vehicle bottom structure according to claim 1, wherein the reinforcing member and the share panel are bonded by an adhesive.

3. The vehicle bottom structure according to claim 1, wherein:
the lower wall of the outer cross member has a projecting portion projecting downward;
an upper surface of the reinforcing member has a recessed portion that receives the projecting portion of the outer cross member;
the recessed portion of the reinforcing member has a plurality of bolt through holes provided at intervals in the vehicle width direction to allow the bolts to pass through the bolt through holes;
putty is disposed in a non-bolt region between adjacent bolt through holes in the recessed portion of the reinforcing member, the putty filling a space between an inner surface of the recessed portion and an outer surface of the projecting portion of the outer cross member; and
the projecting portion of the outer cross member is detachable from the putty.

4. The vehicle bottom structure according to claim 3, wherein the recessed portion of the reinforcing member includes:
a first recessed portion; and
a second recessed portion provided in a center portion of the first recessed portion in the vehicle front-rear direction.

5. The vehicle bottom structure according to claim 1, wherein:
the reinforcing member has a plurality of bolt through holes provided at intervals in the vehicle width direction to allow the bolts to pass through the bolt through holes; and
an upper surface of the reinforcing member has a dent extending in a longitudinal direction of the reinforcing member in a non-bolt region between adjacent bolt through holes.
